(19) United States
(12) Patent Application Publication
(10) Pub. No.: US 2013/0093196 A1
(43) Pub. Date: Apr. 18, 2013

(54) CONTAINER LID LOCKING DEVICE

(71) Applicant: EASYQUIP PTY. LTD., Morwell (AU)

(72) Inventor: Gregory Robert Beer, Morwell (AU)

(73) Assignee: EASYQUIP PTY. LTD., Morwell (AU)

(21) Appl. No.: 13/654,783

(22) Filed: Oct. 18, 2012

(30) Foreign Application Priority Data
Oct. 18, 2011 (AU) 2011904298

(51) Int. Cl. E05C 3/00

(52) U.S. Cl. CPC E05C 3/008
USPC 292/130

(57) ABSTRACT

A locking device for locking a first part of a container to a second part of the container when the container is in a first position and releasing the first part when the container is in a second position, the locking device comprising latch means attached to the first part of the container; a housing disposed on or in the second part of the container; and a moveable member arranged for movement in said housing; such that in said first position said latch means engages said housing to prevent the first part from separating from the second part of the container and in said second position the moveable member, under the action of gravity, engages the latch means to displace the latch means from the housing thereby releasing the first part from the second part of the container enabling ejection of any contents of the container.

### FIELD OF THE INVENTION

This invention relates to a device that automatically locks and unlocks a lid to a container using a releasable member in the form of a latch, that is released by a sliding member which is movable under the force of gravity.

### BACKGROUND OF THE INVENTION

Many bins or containers, particularly large industrial containers, are positioned in an open environment which can be accessed by members of the public. Such containers are used to house waste material which is lifted and emptied by trucks at regular intervals. For this purpose the bins may be positioned near a road that allows easy access by the trucks or positioned on the premises of a business or dwelling where the truck is able to lift, unload and replace the bin in its original position.

As members of the public generally have access to such waste containers, waste material of these people is sometimes emptied into a container without the authority of the person or business that has hired or owns the container. This presents a problem in that the hirer or owner of the container is not able to fully utilise the container for their waste material and there is a potential for other opportunistic users to dispose of waste material that is toxic or harmful to the environment and other persons.

In order to guard against such unauthorised use, it is necessary to lock the lid of the container. Unfortunately, the locking of the lids has created a further difficulty, in that the driver of the truck emptying the bin now has to leave the vehicle to unlock the lid before proceeding to empty the bin. Because of time constraints, the bin is mostly left unlocked after emptying, which defeats the original purpose of locking it. Also, the driver is exposed to a number of Occupational, Health and Safety (OH&S) risks when performing these tasks.

There is therefore a need for a device which can lock the lid of the container, but which will automatically unlock and relock during the emptying process. Some attempts have been made to achieve this, however devices developed to date have exhibited a number of disadvantages.

One particular prior art locking mechanism for containers may be described as the “pipe and cable” device. This has a pipe which is rigidly fixed to pivoting arms either side of the container, with the pipe extending across the lid of the container. One of the pivoting arms is restrained by a cable which is held inside the locking mechanism, and is released when the container is inverted. This arrangement has particular problems in that the locking device is externally mounted and therefore the mechanism can be subjected to mechanical abuse or be overridden by intruders. The locking device does not work with a negative lid load, that is, pressure by the contents causing the lid to bow outwardly due to overloading the container, or by the container lids being buckled. Often the device does not relock due to the weight advantage of the pipe and pivoting arms over the cable returning spring. The manual release mechanism is very cumbersome, involving the disconnection of the restraining cable and lowering of the pipe by hand. Furthermore, securing the bin is the converse process and requires the use of a padlock.

A more recent device provides an internal locking mechanism which uses a retaining hook, a latch, a weight attached to the retaining hook and a manual overriding cam. Again this device does not work with a negative lid load and securing the bin requires a special key, in addition to a padlock, which can become lost or misplaced. The locking mechanism can be breached simply by inserting a thin blade or screwdriver under the lid and pushing the latch backwards. It does not have enough resistance to mechanical abuse due to the small attachment to the lid, and, it has no provision for dealing with the ingress of foreign material, which is necessary, as it is internally mounted.

There is therefore a need to provide a system for locking a container at all times, and for automatically unlocking it when it is being emptied, upon tipping the bin to an inverted position by a truck. There is also a need to provide a locking device which functions satisfactorily with negative lid loading, substantially withstands mechanical abuse or tampering and can deal with the ingress of foreign material.

### SUMMARY OF THE INVENTION

According to a first aspect of the invention, there is provided a locking device for locking a lid of a container when the container is in a first position and releasing the lid when the container is in a second position, the locking device comprising:

latch means attached to the lid of the container;

a housing disposed adjacent a wall of the container; and

a moveable member arranged for movement in said housing;

such that in said first position said latch means engages said housing to prevent the lid from separating from the body of the container and in said second position the moveable member, under the action of gravity, engages the latch means to displace the latch means from the housing thereby releasing the lid from the body of the container enabling ejection of any contents of the container.

According to a second aspect of the invention, there is provided a method of locking a lid of a container comprising the steps of:

providing latch means to secure the lid of the container to a housing attached to the body of the container when the container is in a first position;

providing a moveable member arranged for movement in said housing;

enabling ejection of any contents of the container in a second position whereby, under the action of gravity, the moveable member engages the latch means to displace the latch means from the housing thereby releasing the lid from the body of the container.

According to a third aspect of the invention, there is provided a locking device for locking a first part of a container when the container is in a first position and releasing the first part when the container is in a second position, the locking device comprising:

latch means attached to the first part of the container;

a housing disposed on or in a second part of the container; and

a moveable member arranged for movement in said housing; such that in said first position said latch means engages said housing to prevent the first part from separating from the second part of the container and in said second position the moveable member, under the action of gravity, engages the latch means to displace the latch means from the housing thereby releasing the first part from the second part of the container enabling ejection of any contents of the container.

Movement of the container between the first position and the second position may involve rotation of the container. Preferably, the container rotates from the first position to the second position to empty said contents and returns to said first position such that the latch re-engages with the housing to prevent release of the lid from the container body.

The locking device may further comprise a latch compartment or housing attached to the lid for housing the latch and pivot means about which the latch pivots between a locked position in which the lid cannot separate from the container body and an unlocked position that allows separation of the lid from the container body. Preferably the latch has a hook element for engaging the latch compartment or housing in the locked position. Preferably the locking device further includes a manual release means extending through the container wall and the housing to enable disengagement of the latch from the housing in order to release the lid from the container body. This manual release means is preferably provided with a crosshole for the purpose of inserting a padlock shank to prevent the operation of the manual release means.

### BRIEF DESCRIPTION OF THE DRAWINGS

A preferred embodiment of the invention will hereinafter be described, by way of example only, with reference to the drawings in which:

FIG. 1 is a side view of a locking device for securing the lid of a container;

FIG. 2A is a side sectional view of the locking device of FIG. 1;

FIG. 2B is an enlarged view of the top portion of the locking device of FIG. 2A;

FIG. 2C is a front view of the locking device of FIG. 1;

FIG. 3A is a side view of a moveable or slidable member arranged to slide within a housing of the locking device;

FIG. 3B is a top view of the moveable member of FIG. 3A;

FIG. 4A is a front view of a container to which the locking device is fitted;

FIG. 4B is a side sectional view of the entire container with the locking device fitted therein;

FIG. 4C is a side sectional view of the container in a second tilted position ready for unloading the contents of the container;

FIG. 4D is a magnified view of the locking device shown in FIG. 4C and showing the moveable member contacting a latch such that it is disengaged from the housing so that the lid of the container is released and the contents is able to be expelled from the container;

FIG. 4E is a side sectional view of the container in the tilted second position with the lid of the container separated from the body of the container.

Like reference numerals refer to like parts throughout the several views of the drawings.

### DETAILED DESCRIPTION OF THE PREFERRED EMBODIMENT

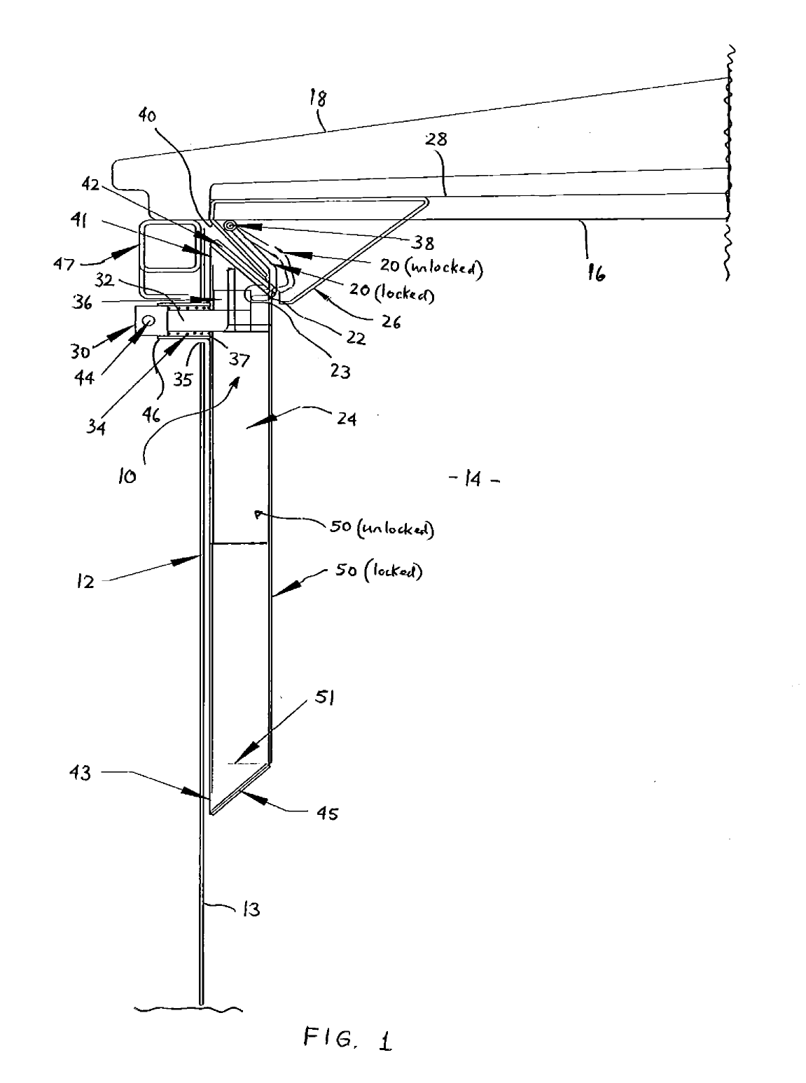

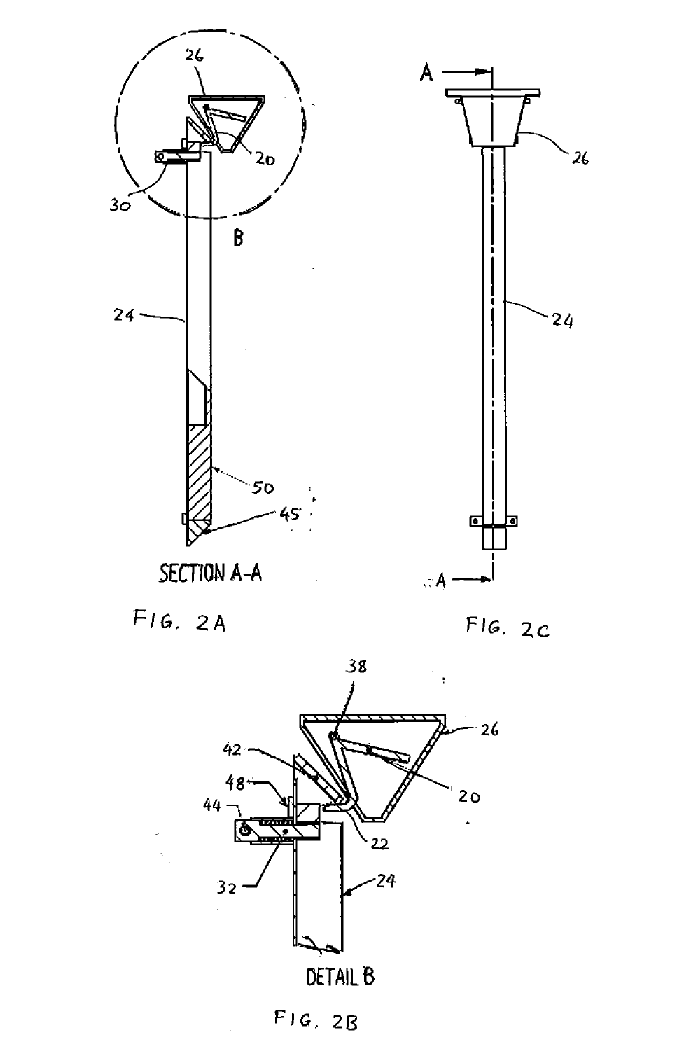

Referring to FIGS. 1, 2a and 2c, there is shown a locking device (10) affixed to first (18) and second (13) parts of a container (14). A first part of the container (14), being lid (18), is adapted to open and close the opening to the container (14). A second part of container (14), being the body of the container (14) includes a front wall (12) of container or bin (14), with part of the locking device (10) affixed to the inner side of wall (12) adjacent a top edge (16) of container (14). The portion of the locking device affixed to second part or body (13) of the container may be affixed to any wall of the container or be positioned in the space of the body of the container bounded by its walls, lid (18) and bottom. The locking device (10) includes a latch (20), which in FIG. 1 is shown in two separate positions. The latch (20) has a hook element (22) which resides within housing (24) affixed to the inside of wall (12) in a closed or latched position such that the lid (18) cannot be removed or opened. A second position is when the hook element (22) is positioned outside and clear of the housing (24) and resides within latch compartment (26). In this second position, the hook element (22), being free of the housing (24), enables the separation of the lid (18) from the body of the container (14) in order to open the container (14). This occurs because the latch compartment (26) is attached to an inner side (28) of the lid (18). The latch compartment (26) and lid (18) are generally made from suitable plastics material, while housing (24), slidable member (50) and all other parts are generally made from steel. A cross member (47) is located at the top of wall (12) for added strength.

The latch (20), through the hook element (22) is configured to move between the closed (first) position and the open (second) position either manually or automatically.

In each of FIGS. 1, 2a, 2b and 2c, the locking device (10) is shown in the locked position and in a resting position. In order to manually open the lid (18) of the container (14), a manual release means in the form of a manual latch-release mechanism (30) is provided in which a user can depress or push the latch bolt (32) of the mechanism (30) against the force of biasing means (34), in the form of a return spring, so that block (36) of the manual latch-release (30) depresses against the hook element (22) so that pushing the block (36) and bolt (32) forces the hook element (22) into the interior of the latch compartment (26) or at least clear of housing (24). The lid (18), together with the latch compartment (26) can therefore be lifted and waste material can be placed in the container (14). The user can release the manual latch-release (30) at this stage and upon closing the lid (18), the latch (20), which pivots about pivot pin (38), resumes its position within an aperture (23) underneath a striker plate (42). As the lid (18) is closed, a surface (40) of the latch compartment (26) contacts striker plate (striker surface (42)) of housing (24), preventing the disengaging of the hook element (22) by external means. The hook element (22) then resides in the aperture (23) underneath the striker plate (42). The striker plate (42) provides a guide for the hook element (22) from an initial point of contact with the striker plate (42) as the lid (18) closes, so that the hook element (22) slides down the plate (42) until it eventually latches underneath the plate (42) in aperture (23) within housing (24). An aperture (44) through the head of the bolt (32) provides for a padlock to be fitted to prevent any displacement or movement of the manual latch-release (30) when the lid (18) is closed. A manual latch-release housing (46) provides an enclosure for the spring (34) and the manual latch-release (30). The bolt (32) protrudes through aperture (35) in the front wall (12) and through a front side wall (37) of the housing (24).

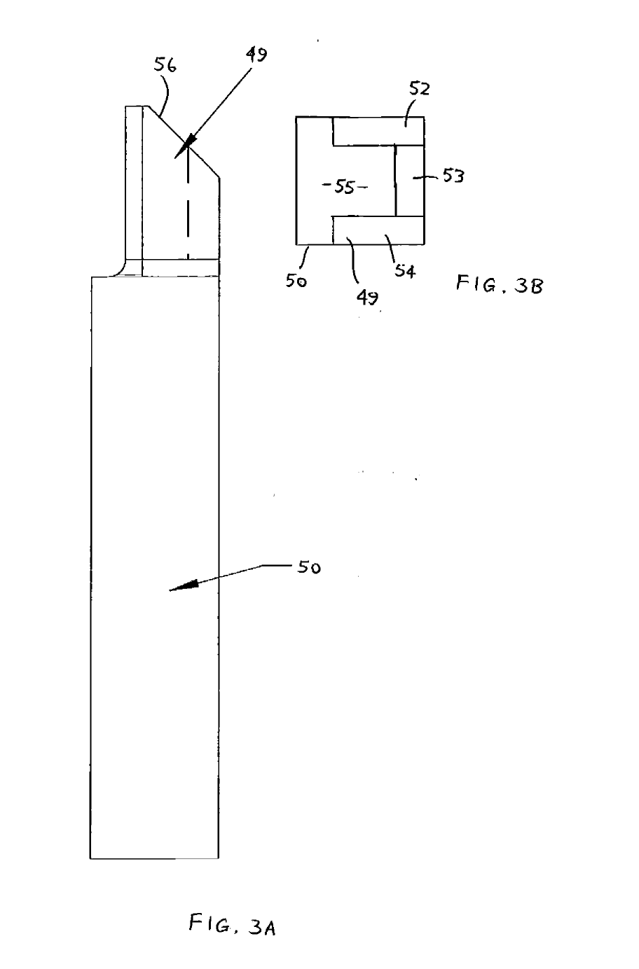

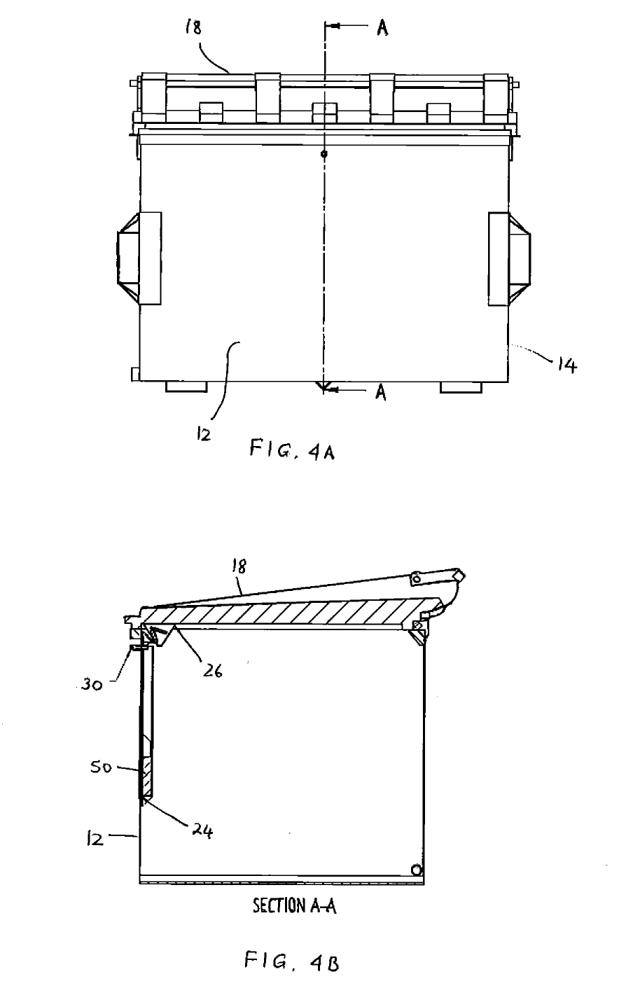

In an automatic mode, the hook element (22) is displaced by a gravity dependent movable or slidable member (50), otherwise termed a sliding release bar. FIG. 1 shows the position of member (50) at the top of housing (24) (for illustrative purposes only) in which the hook element (22) is unlocked and in compartment (26) and also shows where the bottom part of member (50) would be positioned (at 51) when the hook element (22) is in a locked position underneath striker plate (42). A more detailed view of member (50) is shown in FIG. 3a. The housing (24) is essentially a hollow tube in which the member (50) is confined. In a normal resting position as is shown in FIG. 1, the member (50) resides in the bottom region of the housing (24) shown in position (51). In FIG. 3b, the top view of the bar (50), an upper portion or head (49) of the bar defines a U or C-shaped profile having sides (52, 53, 54) with a recess (55) defined therein. The recess (55) is designed to accommodate the manual latch-release block (36) protruding into the housing (24), so that the sliding movement of the bar (50) does not affect or come into contact with the manual latch-release (30) while disengaging the hook element (22) in order to release the plastic lid (18) from the body of the container (14). The sliding member (50) has an angled or ramped face (56), so that as sides (52, 53 & 54) come into contact with the hook element (22) and continue to move towards the striker plate (42) under the force of gravity, eventually the hook element (22) will be expelled from housing (24) and will reside within the latch compartment (26). The striker plate (42) limits the travel of the member (50) within the housing (24).

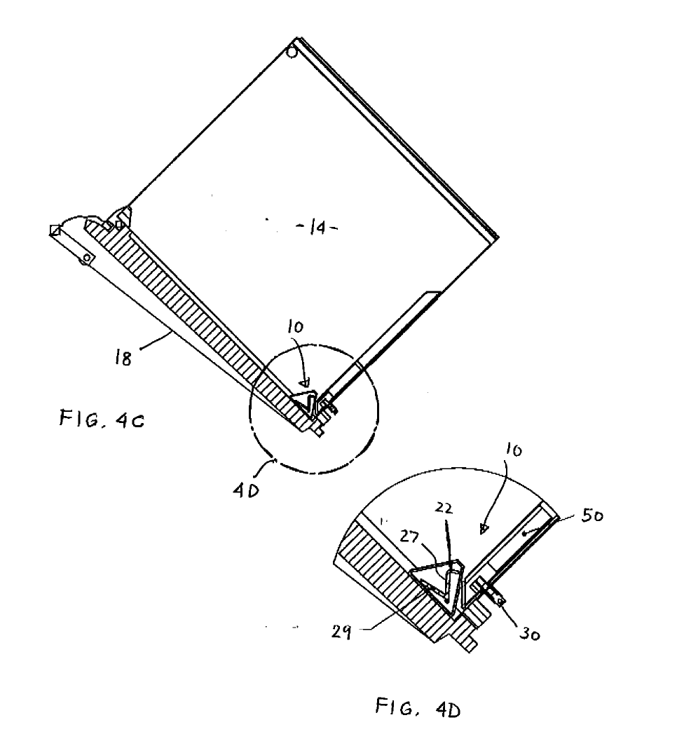

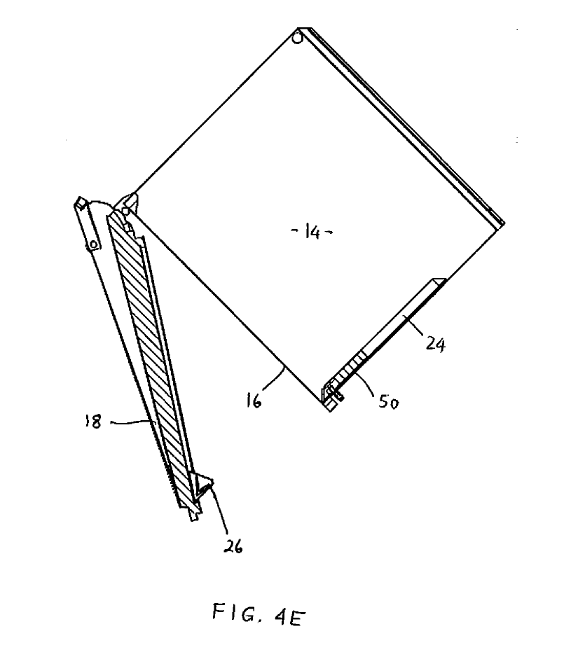

A description of the action of inverting the container (14) in order to open lid (18) and thereby empty the contents of the container (14) will be described in relation to FIGS. 4c to 4e.

Firstly, in relation to FIG. 4a there is shown a front view of the container (14) which has a single lid (18). The locking element (10) will normally be positioned about the midpoint of the inside surface of the front wall (12), near the top of the container (14), to provide maximum protection against users trying to damage or abuse the locking device (10). It also provides for a more balanced action in opening and closing the lid (18). If there are two lids to the container (14), then a separate locking device (10) would be needed for each lid. In FIG. 4b there is shown a side view of the entire container (14) which is taken from the section line AA of FIG. 4a, which shows the locking device (10) in the closed or latched state. The release bar or member (50) is shown located at the bottom of housing (24) in the rest position.

Referring to FIG. 4c the container (14) is shown in a rotated view such that a truck has lifted the container from a first rest position and tilted it to a second position shown in FIG. 4c. At this stage, under gravity, the member (50) has made contact with the hook element (22) to release latch (20) as is shown more clearly in FIG. 4d where the latch (20) resides in the latch compartment (26). The ramp surface (56) of member (50) has continued on to engage the striker plate (42). The lid (18) is now in a position to separate from the remainder of the container (14) (more clearly shown in FIG. 4e) in order to empty the contents of the container (14). The latch (20) is released and held in the position shown in FIG. 4d, such that the hook element (24) does not re-emerge from the latch compartment (26) by virtue of a weight which is formed in portion (29) of the latch (20). Generally latch (20) is formed in three parts, being portion (29) which is angled with respect to middle portion (27) and hook element (22) is at the other end of the middle portion (27) of the latch (20). Thus the weight in portion (29) holds the latch in a position shown in FIG. 4d such that it is maintained within the confines of the latch compartment (26) due to gravity.

Once the container (14) has been emptied it is returned to its resting (first) position shown in FIG. 4b on the ground and lid (18) comes into contact again with the container (14). Latch (20) is then moved under the action of gravity such that the hook element (22) re-engages within the housing (24) underneath the striker plate (42). This thereby locks the lid (18) to the body of the container (14). Under the action of gravity the bar or member (50) has then returned to the position shown in FIG. 2a and FIG. 4b at the lower portion of housing (24).

Housing (24) is open at the top (first) end (41) and the bottom (second) end (43) to allow the egress of foreign material, that may make its way into the housing (24), to re-emerge at the bottom of housing (24) into the remainder of the container (14). If the container is full of material above the level of the bottom of the housing (24) and foreign material remains inside the housing (24), then upon tipping or rotating a container (14) to unload its contents, any foreign matter trapped within the housing (24) will be discharged from the top opening (41) which will now be lower than the bottom opening of housing (24). Either way, foreign matter will not be able to remain within the housing (24). Striker plate (42) is located at the top end (41) and a bottom plate (45) is located at the bottom end (43).

The locking device, when fitted to a container according to the present invention, works to lock and unlock the lid even in extreme, lid distorting, negative lid loads. Being internally mounted, the locking device is designed with deflection plates and openings which allow the egress of foreign matter that builds up or could build up in the housing in which the slidable/moveable member (50) is fitted. The locking device withstands physical abuse, remaining in place even if the lid is destroyed. Forcing the latch to open is not possible due to the arrangement of the striker plate and the latch compartment, and the locking device automatically resets when the lid of the container makes contact again with the body of the container when the container is lowered to the ground. It provides a simple manual release button (mechanism 30) to open the lid of the container by the owner, and is securable with a further locking means such as a padlock. The lid remains latched even when a padlock is not used which prevents wind interference or dispersal of the contents of the container. Various types of lids can be fitted to the container with the locking device, including slope top bins, and the container remains latched until the container is almost within a truck hopper which thereby reduces the risk of environmental pollution.

While the present invention has been shown and described in accordance with several preferred and practical embodiments thereof, it is recognized that departures from the instant disclosure are fully contemplated within the spirit and scope of the invention as defined in the following claims and as interpreted under the Doctrine of Equivalence.

What is claimed is:

1. A locking device for locking a lid of a container when the container is in a first position and releasing the lid when the container is in a second position, the locking device comprising:
latch means attached to the lid of the container;
a housing disposed adjacent a wall of the container; and
a moveable member arranged for movement in said housing;
such that in said first position said latch means engages said housing to prevent the lid from separating from the body of the container and in said second position the moveable member, under the action of gravity, engages the latch means to displace the latch means from the housing thereby releasing the lid from the body of the container enabling ejection of any contents of the container.

2. A locking device according to claim 1 wherein movement of the container between the first position and the second position involves rotation of the container.

3. A locking device according to claim 2 wherein the container rotates from the first position to the second position to empty said contents and returns to said first position such that the latch means re-engages with the housing to prevent release of the lid from the container body.

4. A locking device according to claim 1 further comprising a latch compartment attached to the lid for housing the latch means and pivot means about which the latch means pivots between a locked position in which the lid cannot separate from the container body and an unlocked position that allows separation of the lid from the container body.

5. A locking device according to claim 4 wherein the latch means has a hook element for engaging the housing in the locked position.

6. A locking device according to claim 1 further comprising a manual release means extending through the container wall and the housing to enable disengagement of the latch means from the housing in order to release the lid from the container body.

7. A locking device according to claim 6 wherein the manual release means is pushed inwardly with respect to the container against a biasing force of a resilient means to move and disengage the hook element of the latch means from the housing to release the lid.

8. A locking device according to claim 6 wherein the manual release means is adapted to be secured from use by attachment of a locking apparatus to prevent unwanted release of the lid from the container body.

9. A locking device according to claim 6 wherein the latch means in the second position is prevented from re-engaging with the housing by a weighting means acting under gravity attached to or integrally formed in the latch means.

10. A locking device according to claim 9 whereupon return of the container to the first position the weight means moves to assist re-engagement of the latch means with the housing to prevent release of the lid from the container body.

11. A locking device according to claim 10 wherein the moveable member has a ramped or angled surface at a first end thereof which contacts the latch means under gravity to disengage the latch means from the housing, such that the latch means progressively moves with respect to the ramped or angled surface as the latch means exits the housing.

12. A locking device according to claim 11 wherein the first end of the moveable member is shaped to correspond with a first end of the housing.

13. A locking device according to claim 11 whereupon closing the lid, the latch compartment has a surface that engages with a striker plate at the first end of the housing.

14. A locking device according to claim 13 wherein when the container is in the first position the moveable member is adjacent a second end of the housing.

15. A locking device according to claim 6 wherein the moveable member has a recess that enables the moveable member to pass the manual release means, positioned within the housing, as the container moves to and from the second position.

16. A locking device according to claim 1 wherein the housing is hollow to permit egress from the housing of foreign matter or waste material built up in the housing.

17. A method of locking a lid of a container comprising the steps of:
providing a latch means to secure the lid of the container to a housing attached to the body of the container when the container is in a first position;
providing a moveable member arranged for movement in said housing;
enabling ejection of any contents of the container in a second position whereby, under the action of gravity, the moveable member engages the latch means to displace the latch means from the housing thereby releasing the lid from the body of the container.

18. A method according to claim 17 further comprising the step of rotating the container between the first position and the second position and re-engaging the latch means with the housing when the container is returned to the first position after ejection of any contents in the second position so as to prevent release of the lid from the container body.

19. A method according to claim 17 further comprising providing a latch compartment attached to the lid for housing the latch means and pivot means about which the latch means pivots between a locked position in which the lid cannot separate from the container body and an unlocked position that allows separation of the lid from the container body.

20. A locking device for locking a first part of a container when the container is in a first position and releasing the first part when the container is in a second position, the locking device comprising:
latch means attached to the first part of the container;
a housing disposed on or in a second part of the container; and
a moveable member arranged for movement in said housing;
such that in said first position said latch means engages said housing to prevent the first part from separating from the second part of the container and in said second position the moveable member, under the action of gravity, engages the latch means to displace the latch means from the housing thereby releasing the first part from the second part of the container enabling ejection of any contents of the container.
